(19) United States
(12) Patent Application Publication
(10) Pub. No.: US 2025/0332878 A1
(43) Pub. Date: Oct. 30, 2025

(54) MULTI-ARTICULATED GROUND VEHICLE WITH ACTIVE ATTITUDE AND HEIGHT CONTROL

(71) Applicant: Lunar Outpost Inc., Golden, CO (US)

(72) Inventors: Andrew Josef Gemer, Lafayette, CO (US); Justin Cyrus, Golden, CO (US); Van Wagner, Lakewood, CO (US)

(21) Appl. No.: 19/189,760

(22) Filed: Apr. 25, 2025

Related U.S. Application Data
(60) Provisional application No. 63/639,542, filed on Apr. 26, 2024.
(60) Provisional application No. 63/639,537, filed on Apr. 26, 2024.

(51) Int. Cl. B60G 17/016

(52) U.S. Cl. CPC B60G 17/016; B60G 2202/42; B60G 2204/419; B60G 2500/32; B60G 2800/01

(57) ABSTRACT

A system for sensing, controlling, and/or maintaining the pose (e.g., a heading, attitude, and/or elevation) of a ground-based vehicle is disclosed, which allows precise control of the orientation of the vehicle wheels and/or body relative to a ground surface is disclosed. When actuated, the pitch, roll, height, and/or pivot of the wheel axles relative to one another are controlled to achieve a commanded vehicle pose, raise one or more wheels from the ground surface, and/or place the body of the vehicle in contact with the surface, among other examples.

### CROSS-REFERENCE TO RELATED APPLICATION

This application claims priority to U.S. Provisional Application No. 63/639,542, titled “Multi-Articulated Ground Vehicle with Active Attitude and Height Control,” filed on Apr. 26, 2024, and U.S. Provisional Application No. 63/639,537, titled “Multi-Articulated Ground Vehicle with Robotic Actuator and Manipulator and Associated Control Schema,” filed on Apr. 26, 2024, the entire disclosures of which are hereby incorporated by reference in their entirety.

### BACKGROUND

A ground-based vehicle may need to adjust its attitude or elevation relative to the surface it is traveling upon; for instance, to traverse along uneven or sloped terrain while keeping the vehicle body or attached equipment level, or positioning the vehicle body and/or equipment in a controlled way.

It is with respect to these and other general considerations that embodiments have been described. Also, although relatively specific problems have been discussed, it should be understood that the embodiments should not be limited to solving the specific problems identified in the background.

### SUMMARY

Aspects of the present disclosure relate to a ground-based vehicle capable of actively adjusting and/or maintaining its pose (e.g., heading, attitude, and/or height) relative to the surface it is stopped or traveling upon, its elevation above that surface, and/or to raise one or more wheels or suspension elements above that surface, while the remaining wheels stay in contact with that surface. The attitude of the vehicle may be adjusted in either the roll or pitch dimension, or combination thereof, such that the vehicle remains level on an uneven surface, or such that a portion of the vehicle (e.g. the main body, a robotic arm, sensors, instruments, etc.) maintains a specific attitude (angle) and/or elevation (height above) that uneven surface as the vehicle traverses over it.

This adjustment is effected using a mechanism designed to individually raise or lower each wheel (or, as another example, a group of wheels) and/or its attached suspension element, as well as a rotary pivot joint in the portion of the vehicle body between the pairs of wheels (axles), each of which is manually or automatically commanded to a specific orientation, such that the overall vehicle attitude and/or elevation is attained and maintained. One or more sensors aboard the vehicle provide feedback on the current attitude and/or elevation of a set of specific points on the vehicle body relative to the surface. Additionally, or alternatively, information may be obtained about the condition of the surface in the path of travel of the vehicle. Using this information, the pose of the vehicle is determined, and future movements may be calculated and/or planned to maintain the current or a different desired pose of the vehicle as the vehicle traverses along a path over the surface.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following Figures.

FIG. 1A illustrates a top view of a conceptual diagram of a vehicle according to aspects described herein.

FIG. 1B illustrates a detail view of an example pose control assembly according to aspects described herein.

FIG. 1C illustrates a front perspective view of an example vehicle according to aspects described herein.

FIG. 1D illustrates a front perspective view of the example vehicle of FIG. 1C according to another example pose.

FIG. 1E illustrates a front view of the example vehicle of FIG. 1C according to another example pose.

FIG. 1F illustrates a front view of the example vehicle of FIG. 1C according to another example pose.

FIG. 2A illustrates a perspective view of an example payload configuration for a vehicle according to aspects described herein.

FIG. 2B illustrates a perspective view of another example payload configuration for the vehicle of FIG. 2A according to aspects described herein.

FIG. 2C illustrates a perspective view of another example payload configuration for the vehicle of FIG. 2A according to aspects described herein.

FIG. 3 illustrates an example of a suitable computing environment in which one or more aspects of the present application may be implemented.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Embodiments may be practiced as methods, systems or devices. Accordingly, embodiments may take the form of a hardware implementation, an entirely software implementation, or an implementation combining software and hardware aspects. The following detailed description is therefore not to be taken in a limiting sense, and the scope of the present disclosure is defined by the appended claims and their equivalents.

In examples, a ground vehicle is traversing along a surface. For example, the vehicle may be a rover that is driving over an uneven planetary surface. In these and other examples, the vehicle may need to actively adjust its heading, attitude, and/or height above the surface as it traverses. For example, the vehicle may need to maintain a substantially level attitude relative to the gravity vector over a highly uneven surface; alternatively, the vehicle may need to maintain a specified attitude and/or elevation relative to the surface (e.g., a 20-degree angle in both roll and pitch relative to the surface, and/or maintaining a specified point on the body of the vehicle at 20 cm above the surface as the vehicle traverses).

In another example, the vehicle may need to lower the body of the vehicle until it contacts the surface (e.g., for collecting samples from the surface, dissipating electrostatic charge buildup, imaging the surface at a close distance, and/or modifying the lighting conditions (casting a shadow) on the surface for imaging purposes). This action may be affected remotely or without human operator involvement; affected repeatedly; and/or affected in a reliable and repeatable fashion. For instance, reliability may be particularly important in instances where manual intervention is challenging or unavailable, as may be the case for hardware operating on the Moon or on Mars, among other examples. In another example, the disclosed aspects may enable a vehicle to raise one or more wheels above the surface, for example if one wheel became unable to rotate and the vehicle still needed to continue driving without dragging the malfunctioning or inoperable wheel, or to present the wheel for a maintenance operation or change of wheel, among other examples.

Accordingly, aspects of the present disclosure relate to a multi-articulated ground vehicle with active heading, attitude, and height control. The disclosed attitude and height control may allow the articulated body of the vehicle to pivot about a rotary joint; restrict or prevent said joint from moving; lock said joint in a specified rotational position; or actively actuate the joint about its rotational axis to a commanded rotational location. While aspects are described with respect to a rotary joint (e.g., a center rotary pivot joint), it will be appreciated that any of a variety of other joints may be used, including, but not limited to, a translational and/or extensional joint, or a hinge, among other examples. The disclosed attitude and height control may also allow each wheel and attached suspension element to be actuated or commanded to a specific orientation relative to the vehicle body, the surface, or the other wheel and suspension elements, thus resulting in the body or other portion of the vehicle achieving or maintaining a specified height and/or attitude relative to the surface or other part of the vehicle.

While examples are described with respect to various illustrative suspension and vehicle body members, wheels, and terrain interaction features, it will be appreciated that any of a variety of other such aspects may be used in other examples without departing from the spirit of this disclosure. Further, it will be appreciated that any number of actively- or passively-sensed or controlled suspension members, body members and joints, and/or terrain interaction features may be used.

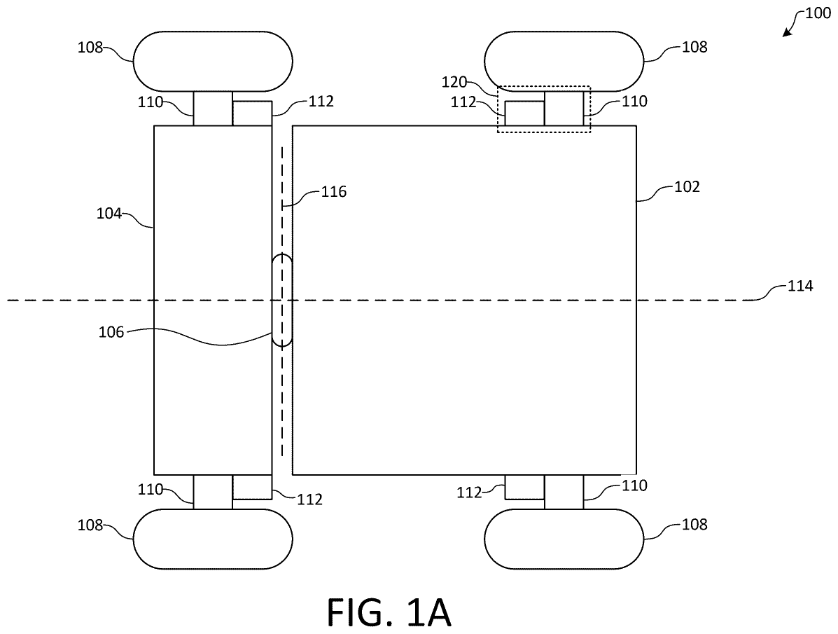

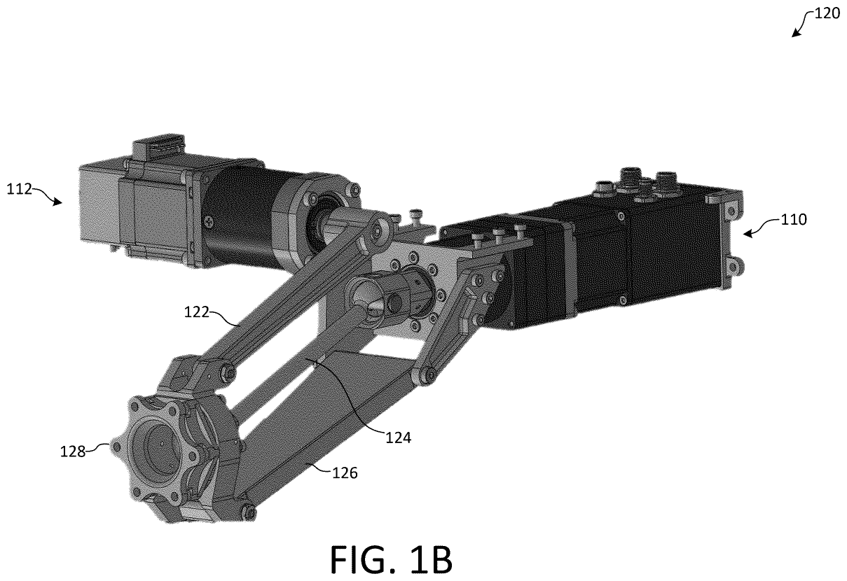

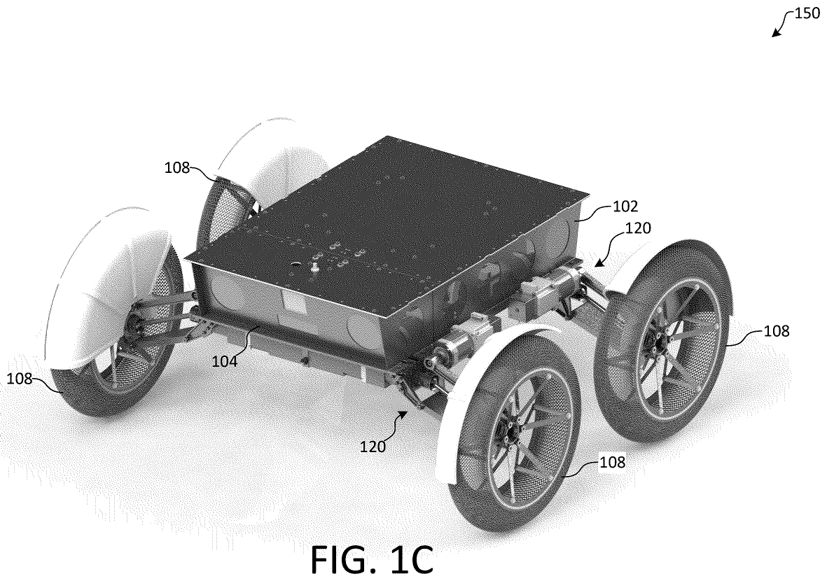

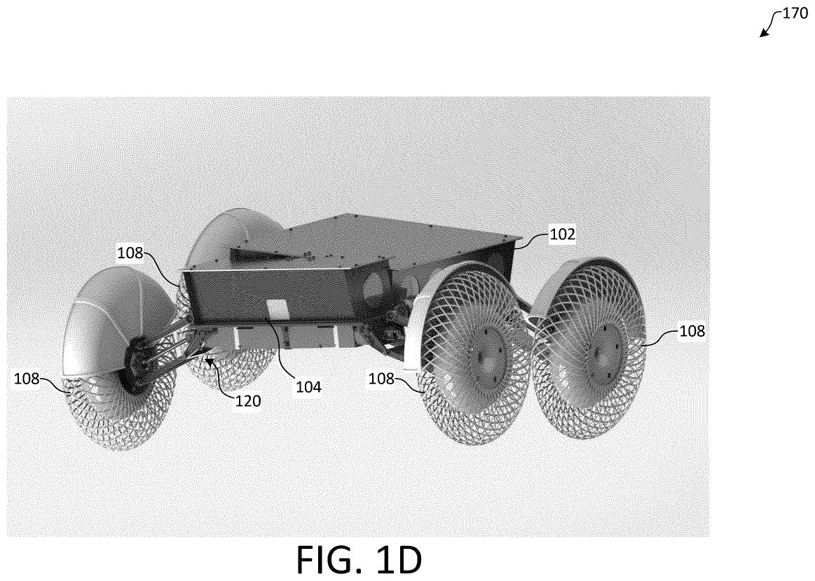

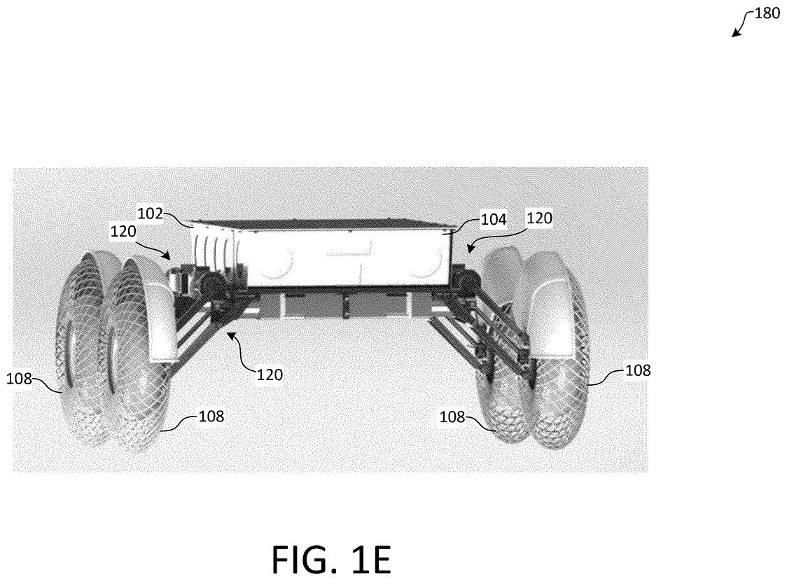

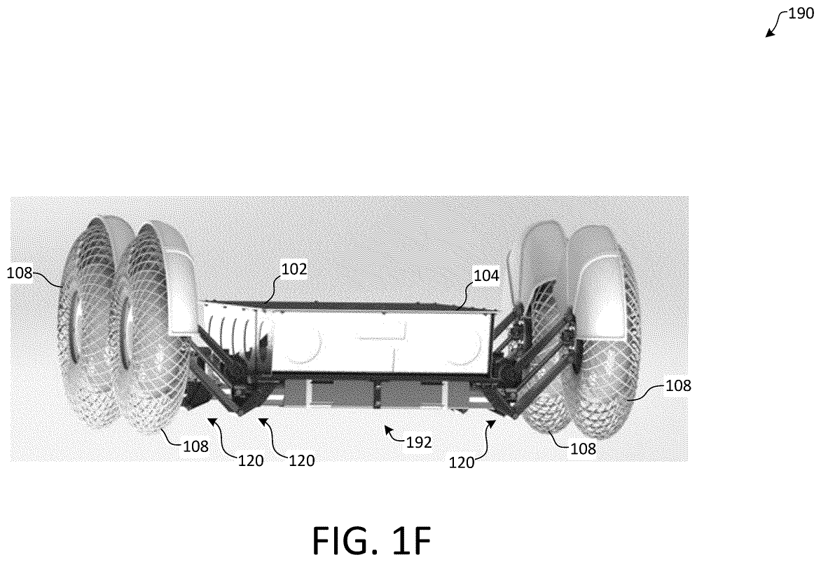

FIG. 1A illustrates a top view of a conceptual diagram of a vehicle 100 according to aspects described herein. As illustrated, vehicle 100 comprises ground-engaging members 108, prime movers 110, and heigh actuators 112. In the depicted example, each ground-engaging member 108 has a corresponding prime mover 110 and height actuator 112, which may together be referred to herein as a pose control assembly 120. While the present example includes a pose control assembly for each ground-engaging member, it will be appreciated that other similar configurations may be used. For example, each ground-engaging member may have a corresponding prime mover while a height actuator corresponds to multiple ground-engaging members (e.g., at a right and a left side of the vehicle), or vice versa, among other examples.

Vehicle 100 further comprises rear portion 102 and front portion 104, which are supported by ground-engaging members 108. As illustrated, rear portion 102 and front portion 104 are coupled by pivot joint 106, which enables rotation about longitudinal axis 114 (e.g., roll) between rear portion 102 and front portion 104. Additionally, or alternatively, pivot joint 106 enables relative rotation between rear portion 102 and front portion 104 about lateral axis 116 (e.g., pitch). Thus, ground-engaging members 108 of rear portion 102 (also referred to as a rear wheel pair) may operate in an independent plane of movement as compared to ground-engaging members 108 of front portion 104 (also referred to as a front wheel pair). In examples, pivot joint 106 comprises an opening, for example through which one or more wires may be disposed to enable electrical coupling between front portion 104 and rear portion 102, among other examples.

While FIG. 1A depicts an example configuration in which vehicle 100 has two portions joined by one pivot joint, it will be appreciated any number of portions and corresponding pivot joints may be used. Additionally, or alternatively, an example segmentation of vehicle 100 into two portions 102 and 104 is provided, though it will be appreciated vehicle 100 may be split according to any of a variety of other proportions (e.g., split in half or split such that front portion 104 constitutes approximately one third of the length of the vehicle, while rear portion 102 constitutes two thirds of the length of the vehicle). In a further example, vehicle 100 may be segmented according to one or more additional or alternative axes (e.g., diagonally and/or along longitudinal axis 114), rather than along lateral axis 116 as in the depicted example.

Thus, pivot joint 106 improves the ability of ground-engaging members 108 to maintain surface contact when traversing uneven terrain. In examples, pivot joint 106 is a passive joint, permitting relative movement between portions 102 and 104 as a result of movement of vehicle 100 (e.g., as it traverses terrain and/or as a result of actuation of one or more of prime movers 108 and/or height actuators 110). In such an example, the passive joint may comprise a rotary encoder to enable a vehicle controller (not pictured) to determine the corresponding pose of vehicle 100 accordingly.

As another example, pivot joint 106 is an active joint, for example comprising an electric motor and, in some examples, a gearbox, thereby permitting active control (e.g., by a vehicle controller) of pivot joint 106 to control the relative position between portions 102 and 104. Inclusion of a gearbox may enable vehicle 100 to maintain a pose with no or with limited current draw by the corresponding electric motor. In examples, the electric motor comprises a rotary encoder, thereby similarly permitting pose determination of vehicle 100. In examples, an active pivot joint improves the ability of vehicle 100 to maneuver terrain, level portion 102 and/or 104 (e.g., relative to the ground and/or horizon; for operation of an instrument supported thereon or therein), and/or achieve active center-of-mass (COM) control (e.g., to increase lifting capacity of a robotic arm supported by vehicle 100), among other examples.

While example sensors are described, it will be appreciated that any of a variety of additional or alternative sensors may be used. For example, vehicle 100 may include one or more visible light and/or infrared cameras, light detection and ranging (LIDAR) sensors, proximity sensors, and/or inertial measurement units (IM Us), among other examples. These and/or other sensors may thus be used to determine a pose of vehicle 100 according to aspects described herein and/or a pose of the vehicle relative to its environment (e.g., as may be determined when maneuvering across uneven terrain).

As discussed above, vehicle 100 includes height actuators 112, each of which, together with a prime mover 110, form a pose control assembly 120. FIG. 1B illustrates a detail view of an example pose control assembly 120 according to aspects described herein.

As illustrated, FIG. 1B comprises prime mover 110 and height actuator 112, aspects of which were discussed above with respect to FIG. 1A and are therefore not redescribed in detail. FIG. 1B further comprises hub 128 to which a ground-engaging member (e.g., ground-engaging member 108 in FIG. 1A) is coupled (e.g., using a set of fasteners, friction, and/or one or more welds).

Prime mover 110 is coupled to hub 128 by driveshaft 124, thereby transferring motive force from prime mover 110 to hub 128 to enable movement of vehicle 100 across a terrain. Hub 128 is further coupled to height actuator 112 by linkage 122, such that rotation (e.g., actuation) of height actuator 112 adjusts an angle between the corresponding ground-engaging member and vehicle 100. Additionally, as illustrated, support member 126 further rotatably couples hub 128 to prime mover 110 and height actuator 112.

Similar to pivot joint 106, height actuator 112 may comprise a rotary encoder, thereby enabling pose determination of vehicle 100 accordingly. Additionally, or alternatively, height actuator 112 comprises a gearbox and/or a brake, thereby enabling a corresponding height to be maintained with no or with reduced current draw by an electric motor of height actuator 112 accordingly. While examples are described herein with respect to a gearbox used in conjunction with an electric motor to reduce/avoid back-driving, it will be appreciated that a brake or other mechanism may additionally or alternatively be used in other examples.

FIG. 1C illustrates a front perspective view 150 of the example vehicle 100 according to aspects described herein. Indeed, similar to FIGS. 1A and 1B, vehicle 100 includes ground-engaging members 108 that support rear portion 102 and front portion 104. Additionally, vehicle 100 includes pose control assemblies 120 that enable height adjustment for each ground-engaging member 108. Since each ground-engaging member 108 has a corresponding pose control assembly 120, each ground-engaging member 108 can be raised/lowered independent of other ground-engaging members. Such control may be in addition to or as an alternative to an active center joint as was discussed above with respect to FIG. 1A. As noted above, such aspects may enable improved maneuverability across terrain and/or dynamic COM control (e.g., as may aid in operation of one or more payloads mounted on and/or disposed within vehicle 100).

As another example, front portion 104 and/or rear portion 102 may be oriented toward or away from the Sun, thereby increasing or decreasing Sun exposure accordingly. For instance, if portion 102 and/or 104 comprises a solar panel, it may be advantageous to dynamically orient the one or more portions to increase Sun exposure (e.g., as compared to a pose in which the top of vehicle 100 is substantially parallel to the ground). As another example, if portion 102 and/or 104 comprises a radiator, it may be beneficial to dynamically orient the one or more portions to decrease Sun exposure, thereby decreasing heat accumulation by the radiator from the Sun.

Thus, pose assemblies 120 may be dynamically adjusted (e.g., as vehicle 100 traverses terrain) to either increase, decrease, or maintain Sun exposure, among other examples. Such aspects may be in addition to or as an alternative to dynamic COM control and/or pose control for improved maneuverability across such terrain, among other examples. As a result, vehicle 100 may be suited for operation along the equator and/or at a pole of a celestial body, as such environments may each have different thermal and/or power generation considerations associated therewith. Additional example aspects of such dynamic vehicle control are discussed by U.S. application Ser. No. 18/048,020, titled “Environment-Based Thermal Management,” the entire disclosure of which is hereby incorporated by reference in its entirety.

FIG. 1D illustrates a front perspective view 170 of the example vehicle of FIG. 1C according to another example pose. As illustrated, view 170 displays the action of an example center rotary pivot joint (e.g., pivot joint 106 in FIG. 1A) according to aspects described herein. Thus, the forward pair of ground-engaging members 108 and the rearward wheel pair of ground-engaging members 108 are able to move in independent planes of movement.

FIG. 1E illustrates a front view of the example vehicle of FIG. 1C according to another example pose. As illustrated, pose control assemblies 120 are commanded to raise the elevation of vehicle 100 (e.g., including rear portion 102 and front portion 104) to a high and substantially level elevation above the driving surface. As noted above, each ground-engaging member 108 is sensed, actuated, and controlled independently (e.g., by controlling pose control assemblies 120, as may include a rotary encoder, among other sensors), such that vehicle 100 can either be maintained at an existing pose (e.g., level) during traversal across an uneven surface, or commanded to another pose (e.g., a specific heading, attitude and/or elevation) relative to the surface, among other examples. In the example depicted in FIG. 1E, a pose having a high elevation may increase ground clearance (e.g., thereby improving maneuverability across obstacles) and/or reduce radiative heat transfer between vehicle 100 and the ground.

FIG. 1F illustrates a front view of the example vehicle 100 of FIG. 1C according to another example pose. As illustrated, vehicle 100 is in a pose where pose control assemblies 120 have been commanded to lower the elevation of vehicle 100, such that bottom surface 192 of vehicle 100 comes in contact with the surface. Contrary to the pose depicted in FIG. 1E, the present pose may improve radiative heat transfer between vehicle 100 and the ground.

A s another example, a similar pose may be used for storage during transit (e.g., on a lander, to improve coupling between vehicle 100 and the lander). In such an example, vehicle 100 may then assume a different pose (e.g., similar to FIG. 1E or 1C) after arrival, thereby increasing ground clearance and enabling vehicle 100 to exit the lander accordingly.

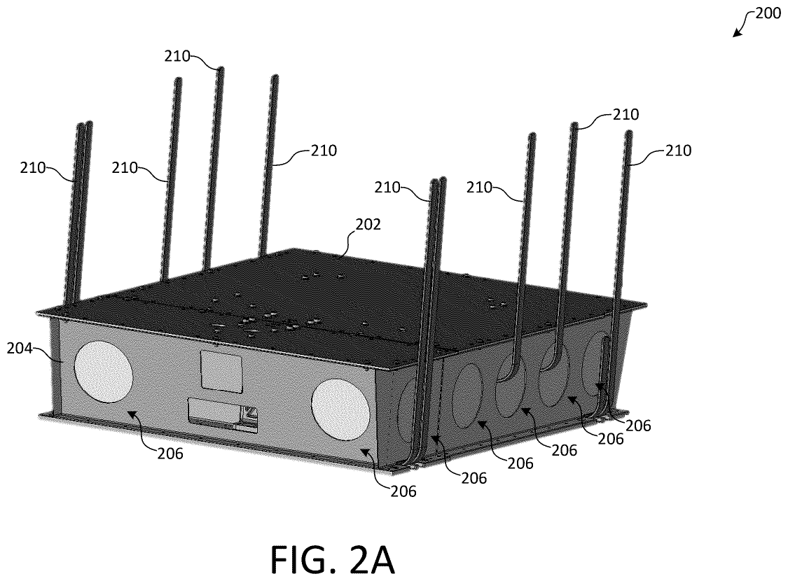

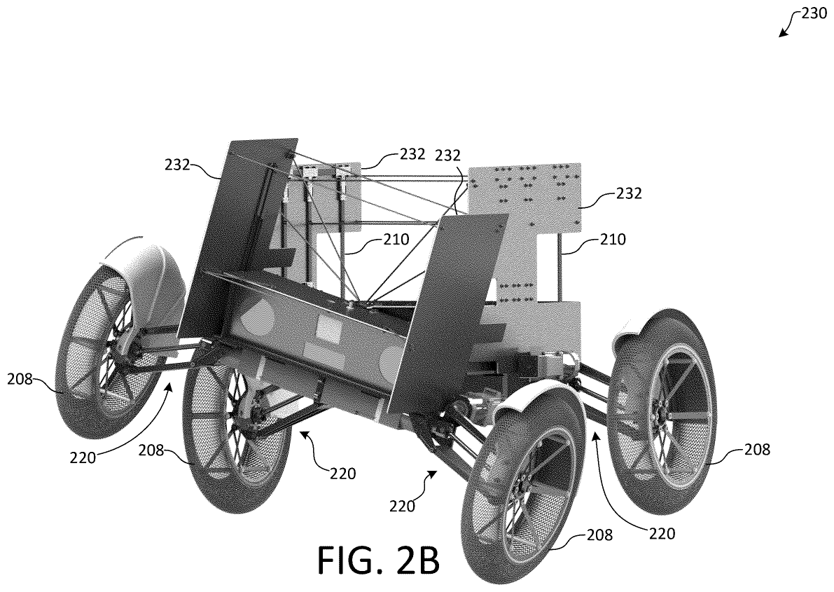

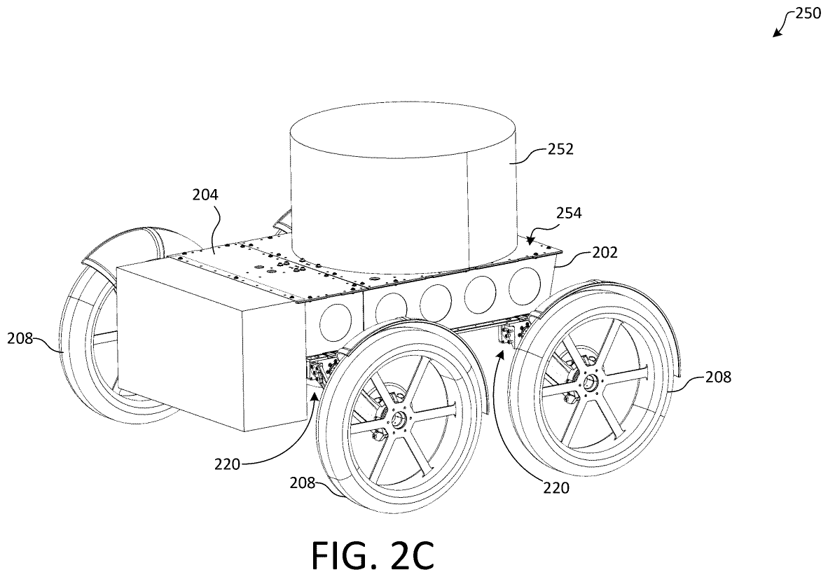

FIG. 2A illustrates a perspective view of an example payload configuration for a vehicle 200 according to aspects described herein. As illustrated, vehicle 200 comprises front portion 204 and rear portion 202, aspects of which may be similar to those discussed above with respect to vehicle 100 of FIGS. 1A-1F. Indeed, portions 202 and 204 may be supported by ground-engaging members (not pictured, see FIGS. 2B and 2C, reference numeral 208), with pose control established via pose control assemblies 220 (FIGS. 2B and 2C; see also FIG. 1B) according to aspects described herein.

Vehicle 200 includes windows 206 which, according to the present example, are radio and/or thermally transparent. Accordingly, a payload disposed inside of portions 202 and 204 may engage in radio communication with a device external to vehicle 200 and/or may exhaust excess heat via windows 206. As illustrated, windows 206 are covered with a film (e.g., gallium foil), for example to reduce dust ingress, though it will be appreciated that, in other examples, alternative film or other coverings may be used. In another example, one or more windows 206 may each be an opening in the body of vehicle 200 (e.g., with no corresponding covering). While example placements of windows 206 are depicted in FIGS. 2A, 2B, and 2C, it will be appreciated that additional, fewer, or alternate window locations may be used in other examples.

The depicted payload configuration further comprises heat pipes 210, which, in addition to or as an alternative to windows 206, may serve to thermally couple a payload within vehicle 200 to its external environment. For example, heat pipes 210 may exhaust excess heat from within vehicle 200 and/or may transfer heat from the environment to one or more components therein (e.g., depending on an environment in which vehicle 200 is operating). Similar to windows 206, it will be appreciated that the depicted configuration of heat pipes 210 is provided as an example and, in other examples, additional, fewer, or alternate heat pipe locations may be used in other examples.

FIG. 2B illustrates a perspective view 250 of another example payload configuration for the vehicle of FIG. 2A according to aspects described herein. Aspects of FIG. 2B are similar to those discussed above with respect to FIG. 2A and are therefore not redescribed in detail. For example, similar to FIG. 2A, FIG. 2B comprises heat pipes 210, which are further coupled to radiator panels 232. Thus, as a result of the depicted payload further comprising radiator panels 232, heat transfer is increased as compared to the example depicted in FIG. 2A. It will be appreciated that the depicted example may be a payload configuration for use at an equatorial region, as radiator panels 232 are substantially normal to the sky, thereby reducing Sun exposure. Other configurations may be used for other operating environments (e.g., with angled or articulating radiator panels).

In some examples, heat pipes 210 are selectively coupled to one or more heat-generating (and/or heat-sensitive) components of vehicle 200, for example using a thermal switch according to aspects described by U.S. patent application Ser. No. 18/821,513, titled “Active Thermal Switch,” the entire disclosure of which is hereby incorporated by reference.

FIG. 2C illustrates a perspective view of another example payload configuration for the vehicle of FIG. 2A according to aspects described herein. As illustrated, instrument 252 is disposed on top surface 254 of rear portion 202. According to the disclosed aspects, pose control assemblies 220 (and/or a pivot joint between portions 202 and 204, see pivot joint 106 in FIG. 1A) may be controlled so as to maintain a substantially level surface for operation of instrument 252. As another example, pose control assemblies 220 and/or a pivot joint may be controlled to angle top surface 254 according to any of a variety of additional or alternative objections (e.g., dynamic COM control).

Thus, while example control schemes, vehicle configurations, and corresponding payloads are described herein, it will be appreciated that the disclosed aspects may be applicable to any of a variety of other schemes, configurations, and/or payloads in other examples.

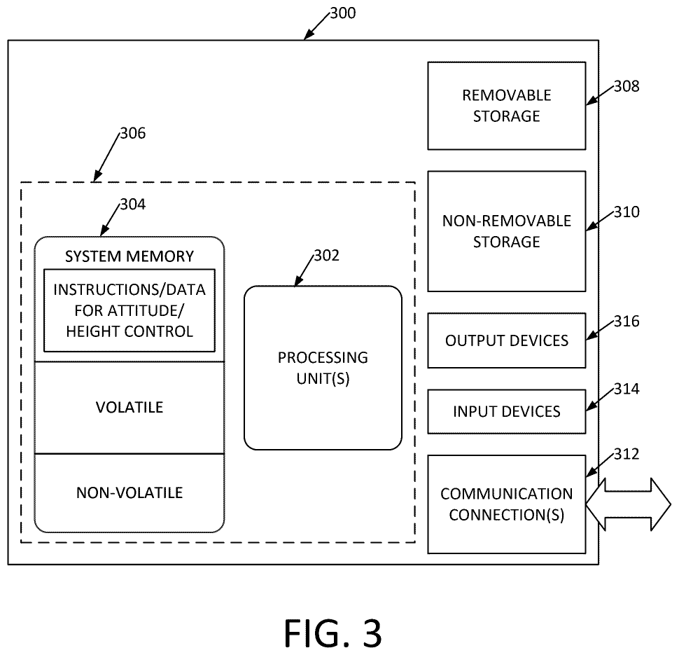

FIG. 3 illustrates an example of a suitable computing environment 300 in which one or more of the present embodiments may be implemented. For example, aspects of computing environment 300 may be used by a controller, such as a vehicle controller of a vehicle according to aspects described herein. This is only one example of a suitable computing environment and is not intended to suggest any limitation as to the scope of use or functionality. Other well-known computing systems, environments, and/or configurations that may be suitable for use include, but are not limited to, personal computers, server computers, hand-held or laptop devices, multiprocessor systems, microprocessor-based systems, programmable consumer electronics such as smart phones, network PCs, minicomputers, mainframe computers, distributed computing environments that include any of the above systems or devices, and the like.

In its most basic configuration, computing environment 300 typically may include at least one processing unit 302 and memory 304. Depending on the exact configuration and type of computing device, memory 304 (storing, among other things, APIs, programs, etc. and/or other components or instructions to implement or perform the system and methods disclosed herein, etc.) may be volatile (such as RAM), non-volatile (such as ROM, flash memory, etc.), or some combination of the two. This most basic configuration is illustrated in FIG. 3 by dashed line 306. Further, environment 300 may also include storage devices (removable, 308, and/or non-removable, 310) including, but not limited to, magnetic or optical disks or tape. Similarly, environment 300 may also have input device(s) 314 such as a keyboard, mouse, pen, voice input, etc. and/or output device(s) 316 such as a display, speakers, printer, etc. Also included in the environment may be one or more communication connections, 312, such as LAN, WAN, point to point, etc.

Computing environment 300 may include at least some form of computer readable media. The computer readable media may be any available media that can be accessed by processing unit 302 or other devices comprising the computing environment. For example, the computer readable media may include computer storage media and communication media. The computer storage media may include volatile and nonvolatile, removable and non-removable media implemented in any method or technology for storage of information such as computer readable instructions, data structures, program modules or other data. The computer storage media may include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transitory medium, which can be used to store the desired information. The computer storage media may not include communication media.

The communication media may embody computer readable instructions, data structures, program modules, or other data in a modulated data signal such as a carrier wave or other transport mechanism and includes any information delivery media. The term “modulated data signal” may mean a signal that has one or more of its characteristics set or changed in such a manner as to encode information in the signal. For example, the communication media may include a wired media such as a wired network or direct-wired connection, and wireless media such as acoustic, RF, infrared and other wireless media. Combinations of the any of the above should also be included within the scope of computer readable media.

The computing environment 300 may be a single computer operating in a networked environment using logical connections to one or more remote computers. The remote computer may be a personal computer, a server, a router, a network PC, a peer device or other common network node, and typically includes many or all of the elements described above as well as others not so mentioned. The logical connections may include any method supported by available communications media. Such networking environments are commonplace in offices, enterprise-wide computer networks, intranets, and the Internet.

The different aspects described herein may be employed using software, hardware, or a combination of software and hardware to implement and perform the systems and methods disclosed herein. Although specific devices have been recited throughout the disclosure as performing specific functions, one skilled in the art will appreciate that these devices are provided for illustrative purposes, and other devices may be employed to perform the functionality disclosed herein without departing from the scope of the disclosure.

As stated above, a number of program modules and data files may be stored in the system memory 304. While executing on the processing unit 302, program modules (e.g., applications, Input/Output (I/O) management, and other utilities) may perform processes including, but not limited to, one or more of the stages of the operational methods described herein.

Furthermore, examples of the invention may be practiced in an electrical circuit comprising discrete electronic elements, packaged or integrated electronic chips containing logic gates, a circuit utilizing a microprocessor, or on a single chip containing electronic elements or microprocessors. For example, examples of the invention may be practiced via a system-on-a-chip (SOC) where each or many of the components illustrated in FIG. 3 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality described herein may be operated via application-specific logic integrated with other components of the computing environment 300 on the single integrated circuit (chip). Examples of the present disclosure may also be practiced using other technologies capable of performing logical operations such as, for example, AND, OR, and NOT, including but not limited to mechanical, optical, fluidic, and quantum technologies. In addition, examples of the invention may be practiced within a general purpose computer or in any other circuits or systems.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A system for dynamically managing a pose of a vehicle, the system comprising:
a pose control assembly coupled to a first ground-engaging member of a first set of ground-engaging members, the pose control assembly being configured to adjust the attitude of at least a first portion of the vehicle;
a pivot joint providing articulation between the first portion and a second portion of the vehicle, thereby allowing the first set of ground-engaging members to articulate relative to a second set of ground-engaging members of the vehicle; and
a set of sensors to determine a current pose of the vehicle.

2. The system of claim 1, wherein the pose of the vehicle comprises at least one of a heading, an attitude, or an elevation.

3. The system of claim 1, wherein the pose control assembly is a first pose control assembly and further comprising a second pose control assembly coupled to a second ground-engaging member of the second set of members and configured to adjust the attitude of the second portion of the vehicle.

4. The system of claim 3, further comprising:
a third pose control assembly coupled to a third ground-engaging member of the first set of ground-engaging members and configured to adjust an attitude of the first portion of the vehicle; and
a fourth pose control assembly coupled to a fourth ground-engaging member of the second set of ground-engaging members and configured to adjust an attitude of the section portion of the vehicle.

5. The system of claim 1, wherein the pose control assembly comprises a height actuator coupled to the first ground-engaging member that, when actuated, changes a relative angle between the first ground engaging member and the first portion of the vehicle.

6. The system of claim 5, wherein the pose control assembly further comprises a gearbox operably coupled between the height actuator and the first ground-engaging member.

7. The system of claim 1, wherein the pivot joint is a passive pivot joint configured to rotatably couple the first portion and the second portion.

8. The system of claim 1, wherein the pivot joint is an active pivot joint comprising an electric motor that, when actuated, adjusts a rotation between the first portion and the second portion about a longitudinal axis of the vehicle.

9. The system of claim 1, wherein the set of sensors comprises a rotary encoder for at least one of the pose control assembly or the pivot joint.

10. The system of claim 1, wherein a longitudinal length of the first portion of the vehicle is greater than a longitudinal length of the second portion of the vehicle.

11. A vehicle, comprising:
a front set of ground-engaging members;
a rear set of ground-engaging members;
a first body portion coupled to the front set of ground-engaging members by a first pose control assembly configured to adjust a first attitude of the first body portion of the vehicle;
a second body portion coupled to the rear set of ground-engaging members by a second pose control assembly configured to adjust a second attitude of the second body portion of the vehicle; and
a pivot joint coupling the first body portion and the second body portion.

12. The vehicle of claim 11, further comprising:
a third pose control assembly further coupling the first body portion to the front set of ground-engaging members; and
a fourth pose control assembly coupling the second body portion to the rear set of ground-engaging members.

13. The vehicle of claim 11, wherein each pose control assembly comprises a height actuator coupled to a corresponding ground-engaging member that, when actuated, changes a relative angle between the relative ground-engaging member and the vehicle.

14. The vehicle of claim 13, wherein the pose control assembly further comprises a gearbox operably coupled between the height actuator and the respective ground-engaging member.

15. The vehicle of claim 11, wherein the pivot joint is a passive pivot joint configured to rotatably couple the first portion and the second portion.

16. The vehicle of claim 11, wherein the pivot joint is an active pivot joint comprising an electric motor that, when actuated, adjusts a rotation between the first portion and the second portion about a longitudinal axis of the vehicle.

17. The vehicle of claim 11, further comprising a set of sensors for determining a pose of the vehicle.

18. The vehicle of claim 17, wherein the pose of the vehicle comprises at least one of a heading, an attitude, or an elevation.

19. The vehicle of claim 17, wherein the set of sensors comprises a rotary encoder for at least one of the pose control assembly or the pivot joint.

20. The vehicle of claim 11, wherein a longitudinal length of the first portion of the vehicle is less than a longitudinal length of the second portion of the vehicle.
